(19) United States
(12) Patent Application Publication
(10) Pub. No.: US 2026/0119101 A1
(43) Pub. Date: Apr. 30, 2026

(54) CLOUD COMMUNICATIONS TO/FROM PRINTING DEVICES

(71) Applicants: Tadao Yamasaki, Boulder, CO (US); Mihai Ciocarlie, Timisoara (RO); Gerald Donald Boldt, Longmont, CO (US)

(72) Inventors: Tadao Yamasaki, Boulder, CO (US); Mihai Ciocarlie, Timisoara (RO); Gerald Donald Boldt, Longmont, CO (US)

(73) Assignee: Ricoh Company, Ltd., Tokyo (JP)

(21) Appl. No.: 18/931,892

(22) Filed: Oct. 30, 2024

(51) Int. Cl. G06F 3/12

(52) U.S. Cl. CPC G06F 3/1288; G06F 3/1209; G06F 3/1237

(57) ABSTRACT

System, method, and software for a cloud printing service. In an embodiment, a cloud print mediator is configured to communicatively couple between a plurality of printers and a cloud printing service. The cloud print mediator is configured to establish a first network connection with the cloud printing service that uses a secure messaging protocol, establish a second network connection with the cloud printing service that uses a secure transfer protocol, receive a print request to print a print job from the cloud printing service over the first network connection, retrieve print data for the print job from the cloud printing service over the second network connection, and submit the print job to a selected printer of the plurality.

### TECHNICAL FIELD

The following disclosure relates to the field of printing, and more particularly, to printing services.

### BACKGROUND

Cloud printing services connect devices, such as smartphones, laptops, tablets, personal computers (PCs), etc., with one or more network-connected printers. A user may access the cloud printing service to submit a print job to a network-connected printer. For example, a user may access a commercial cloud printing service to submit a print job to print advertising or marketing materials, product manuals, books, invoices/bills, blueprints, mailings, etc. The cloud printing service, in turn, submits the print job to a printer capable of printing the print job. Some potential issues may arise due to security concerns and/or cost involved in communication between the cloud printing service and a printer.

### SUMMARY

Embodiments described herein provide enhanced communications with a cloud printing service. As an overview, an apparatus referred to as a cloud print mediator is implemented on-ground or on-premises with one or more printers, and is configured act as an intermediary between the cloud printing service and the printer(s). The cloud print mediator communicates with the cloud printing service over a light-weight messaging protocol (e.g., application layer protocol), and also over a secure transfer protocol (e.g., an application layer protocol). For example, the light-weight messaging protocol may be used to convey instruction or command messages (e.g., create a printer, submit print job, etc.) from the cloud print service to the cloud print mediator, to convey printer status messages from the cloud print mediator to the cloud print service, etc. The secure transfer protocol may be used to convey a job file, a job ticket, and/or other print data from the cloud print service to the cloud print mediator, to convey device capabilities of printers from the cloud print mediator to the cloud print service, etc. One technical benefit is smaller data may be conveyed over the light-weight messaging protocol, which may have an associated cost per number of messages, while larger data may be conveyed over the secure transfer protocol. This may reduce the overall cost associated with the cloud printing service. Another technical benefit is the cloud print mediator may use a standardized or default port to communicate with the cloud printing service, and a customer does not need to open a non-standardized port to implement communication between a cloud printing service and a printer.

In an embodiment (also referred to as aspects), an apparatus comprises a cloud print mediator configured to communicatively couple between a plurality of printers and a cloud printing service provisioned on a cloud-computing platform. The cloud print mediator comprising at least one processor and memory. The at least one processor is configured to cause the cloud print mediator at least to establish a first network connection with the cloud printing service that uses a secure messaging protocol, establish a second network connection with the cloud printing service that uses a secure transfer protocol, receive a print request to print a print job from the cloud printing service over the first network connection, retrieve print data for the print job from the cloud printing service over the second network connection, and submit the print job to a selected printer of the plurality.

In an embodiment, a method of communicating with a cloud printing service is disclosed. The method comprises, in a cloud print mediator communicatively coupled between a plurality of printers and the cloud printing service provisioned on a cloud-computing platform, establishing a first network connection with the cloud printing service that uses a secure messaging protocol, establishing a second network connection with the cloud printing service that uses a secure transfer protocol, receiving a print request to print a print job from the cloud printing service over the first network connection, retrieving print data for the print job from the cloud printing service over the second network connection, and submitting the print job to a selected printer of the plurality.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 illustrates a cloud printing architecture.

FIG. 2 illustrates another cloud printing architecture in an illustrative embodiment.

FIG. 3 is a block diagram of a cloud printing service in an illustrative embodiment.

FIG. 4 is a block diagram of a customer portal in an illustrative embodiment.

FIG. 5 is a block diagram of a producer portal in an illustrative embodiment.

FIG. 6 is a block diagram of a cloud print mediator in an illustrative embodiment.

FIGS. 7A-7B illustrate communications involving a cloud printing service in illustrative embodiments.

FIG. 8 illustrates communication between a cloud print mediator and a cloud printing service in an illustrative embodiment.

FIG. 9 illustrates communication between a cloud print mediator and a cloud printing service in an illustrative embodiment.

FIG. 10 illustrates communication between a cloud print mediator and a cloud printing service in an illustrative embodiment.

FIGS. 11A-11B are flow charts illustrating a method of communicating with a cloud printing service in an illustrative embodiment.

FIGS. 12A-12B are message diagrams illustrating communications with a cloud printing service in an illustrative embodiment.

FIG. 13 is a flow chart illustrating a method of communicating with a cloud printing service in an illustrative embodiment.

FIG. 14 is a message diagram illustrating communications with the cloud printing service 210 in an illustrative embodiment.

FIG. 15 illustrates a processing system operable to execute a computer readable medium embodying programmed instructions to perform desired functions in an illustrative embodiment.

### DETAILED DESCRIPTION

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

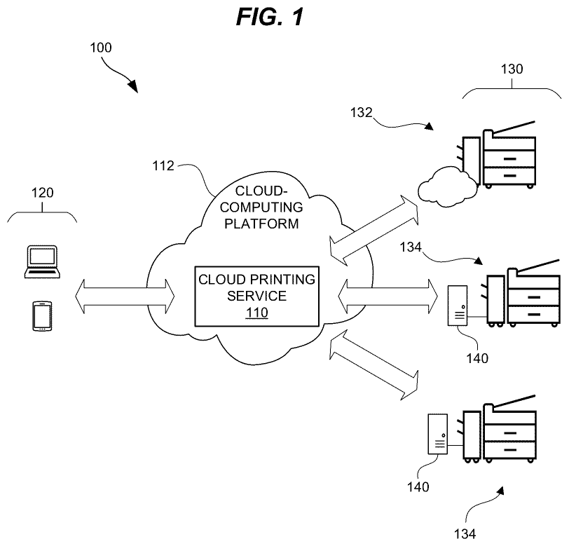

FIG. 1 illustrates a cloud printing architecture 100. Cloud printing architecture 100 comprises a cloud printing service 110 implemented on a cloud computing platform 112. Cloud-computing allows users access to a variety of services over an internet connection. Some examples of cloud-computing platform 112 may comprise Amazon Web Services (AWS), Google Cloud, Microsoft Azure, etc. Cloud printing service 110 connects end user devices 120 (e.g., a smartphone, laptop, tablet, personal computer (PC), etc.) with one or more network-connected printers 130. A printer 130 used in cloud printing architecture 100 may comprise a cloud-ready or cloud-enabled printer 132 configured to communicate with the cloud printing service 110. A printer 130 used in cloud printing architecture 100 may comprise a non-cloud-enabled or legacy printer 134 that uses a cloud print mediator 140 to communicate with the cloud printing service 110.

When an end user device 120 is remote from a printer 130 (i.e., not directly or physically connected), the cloud printing service 110 acts as an intermediary to receive a print job from the end user device 120, and submit the print job to the printer 130. For example, cloud printing service 110 may be used for consumer-based cloud printing, where end user devices 120 of an entity submit print jobs through the cloud printing service 110 to a printer 130 owned by the entity. Cloud printing service 110 may be used for professional or commercial cloud printing, where end user devices 120 submit print jobs through the cloud printing service 110 to printers 130 implemented at production facilities (e.g., corporate facilities, commercial facilities, etc.). One benefit is a user is able to submit print jobs from virtually anywhere an internet connection is available.

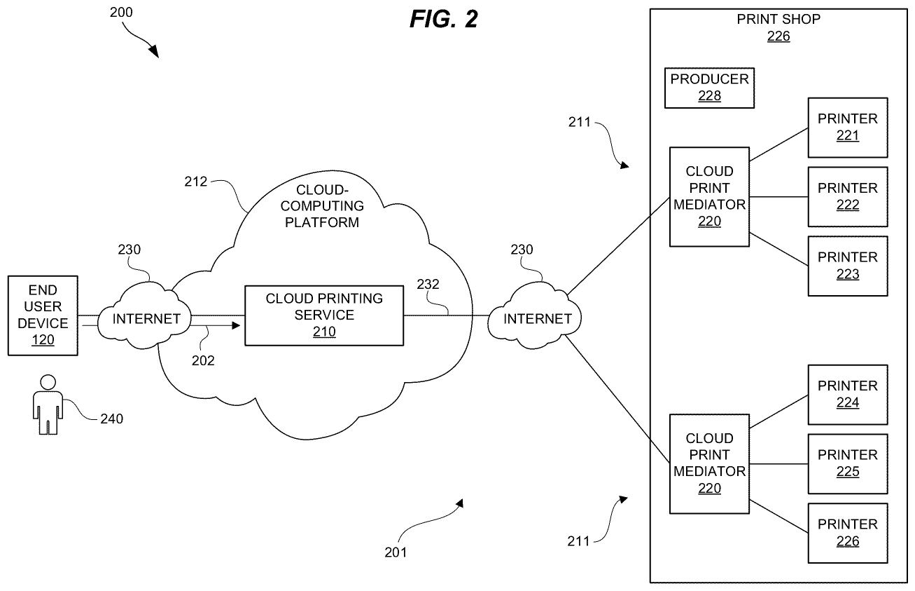

FIG. 2 illustrates another cloud printing architecture 200 in an illustrative embodiment. In this embodiment, cloud printing architecture 200 comprises a cloud printing service 210 implemented on a cloud computing platform 212, and the cloud printing service 210 is configured for professional, commercial, production, or industrial printing. Commercial printing may be performed by Print Service Providers (PSP) or other providers that offer printing services to users/customers in exchange for monetary compensation. For example, a PSP may offer printing services for advertising or marketing materials, product manuals, books, invoices/bills, blueprints, mailings, etc. In general, an owner or operator of a PSP may be referred to as a producer 228 that subscribes to the cloud printing service 210. A PSP may own or operate a variety of printing equipment, referred to generally as a print shop 226. In FIG. 2, print shop 226 includes one or more printers 221-226 and/or other print equipment (e.g., post-print devices, finishing devices, etc.). A printer is an image forming apparatus that performs image formation (printing) on a recording medium on the basis of print data received from a source. Although not shown in FIG. 2, a printer 221-226 generally includes a print controller and one or more print engines. The print controller receives a printer-compliant print stream (e.g., PDL-compliant data), generates rasterized data from the printer-compliant print stream, and transmits the rasterized data to one or more print engines, which mark a print media with the rasterized data. The print engine may use a variety of marking materials for marking a print media, such as ink (e.g., water, solvent, oil, or UV-curable), oil-based paints, additive manufacturing materials, toner, etc. The print media may comprise any type of material upon which ink or another type of marking material is applied, such as paper, plastic, card stock, transparent sheets, a substrate for 3D printing, cloth or fabric, etc.

Print shop 226 may implement multiple printers of the same type, or may implement different types of printers depending on needs of the customers. For example, one or more of the printers 221-226 may comprise a production printer (e.g., continuous-feed inkjet printer, a cut-sheet printer, etc.), a desktop printer, a 3D printer, a plotter or wide-format printer, etc. One or more printers 221-226 may be configured to print on different types or forms of print media, such as standard weight paper, glossy or matte stock, cut-sheet, continuous-forms, etc. One or more printers 221-226 may be configured to print on different media sizes, such as letter, legal, A4, extra-large, etc. One or more printers 221-226 may be configured to print in different colors, such as color or monochrome. One or more printers 221-226 may be configured with different finishing or post-print options, such as glosses or textures, binding, cutting/trimming, embossing, laminating, etc. Thus, each printer 221-226 may have different device capabilities (DEVCAPS) that are provided to the cloud printing service 210.

Printers 221-226 are shown as being at a common location in the example of FIG. 2, but printing equipment may be distributed among multiple, different locations in other examples.

Cloud printing architecture 200 in FIG. 2 may be considered a hybrid cloud architecture 201 that combines the infrastructure of a public cloud (illustrated by cloud-computing platform 212), and on-ground or on-premise infrastructure 211. In an embodiment, the on-premise infrastructure 211 comprises the printers 221-226 and one or more cloud print mediators 220, which may collectively be referred to as a print system. In general, “on-premises” means that the infrastructure exists on-site in contrast to being hosted off-site, such as in a public cloud. In an on-premise infrastructure 211, an entity owns the resources of the infrastructure (e.g., computing resources, networking, storage, software, etc.), and/or has full control over the resources. A cloud print mediator 220 is an information processing apparatus, and comprises a type of on-premise equipment configured to interface one or more printers 221-226 with a cloud printing service 210. As will be described in more detail below, cloud print mediator 220 is communicatively coupled to a cloud printing service 210, and is also communicatively coupled to one or more printers 221-226. For example, cloud print mediator 220 may be directly connected to one or more printers 221-226 via wired or wireless connections, and is connected to the cloud printing service 210 over one or more network (e.g., internet) connections. Thus, printers 221-226 are decoupled or isolated from the cloud print service 210 through the cloud print mediator 220.

At a high level, a user 240 is able to submit a print job 202 (comprising one or more job files, an associated job ticket, etc.) to the cloud printing service 210 through an end user device 120 (also referred to as a host device). The cloud printing service 210 pre-processes the print job 202 (also referred to as preflight) to confirm that the job files are present, valid, correctly formatted, and/or of the desired type, and correct any potential problems. The cloud printing service 210 may then identify or select one or more destinations for the print job 202 (e.g., one or more of the printers 221-226, a hot folder, etc.), and send the print job 202 to the destination(s). For example, cloud printing service 210 may submit the print job 202 to a cloud print mediator 220 for printing on a printer under its domain (i.e., supervised by the cloud print mediator 220). Cloud print mediator 220, in turn, acquires the job data for the print job 202 (e.g., job files and associated job ticket) from the cloud printing service 210, and sends the print job 202 to the selected printer.

Cloud print mediator 220 is shown in FIG. 2 as being able to communicate with the cloud printing service 210 over a network, such as the internet 230. Likewise, end user device 120 is shown as being able to communicate with the cloud printing service 210 over the internet 230. The internet 230 as referred to herein is a system of interconnected computer networks that uses the Internet Protocol suite (e.g., Transmission Control Protocol/Internet Protocol (TCP/IP)) to communicate between networks and devices, although other protocols may be developed in the future.

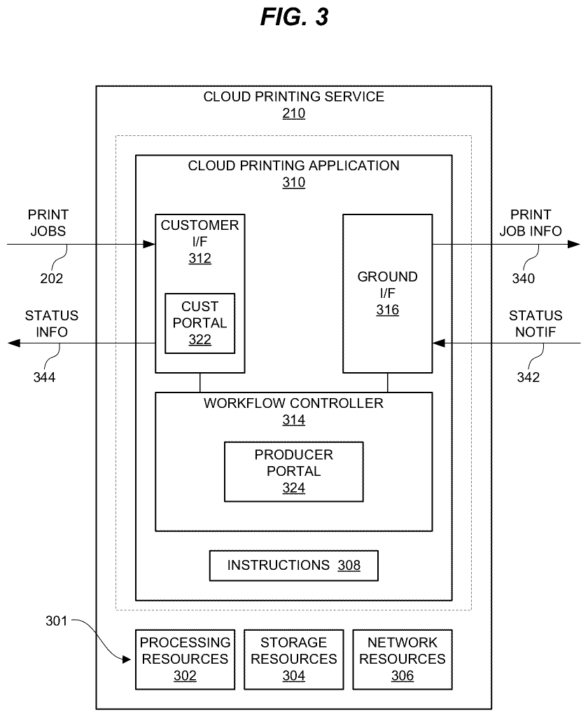

FIG. 3 is a block diagram of a cloud printing service 210 in an illustrative embodiment. To implement the cloud printing service 210, cloud resources 301 are provisioned in a cloud-computing environment (e.g., AWS), such as processing resources 302, storage resources 304, and/or network resources 306, although other resources are considered herein. A cloud printing application 310 may be built or executed on the provisioned resources with instructions 308, programming, code, etc. In an embodiment, cloud printing application 310 provides a user or customer interface (I/F) 312, a workflow controller 314, and a ground interface 316.

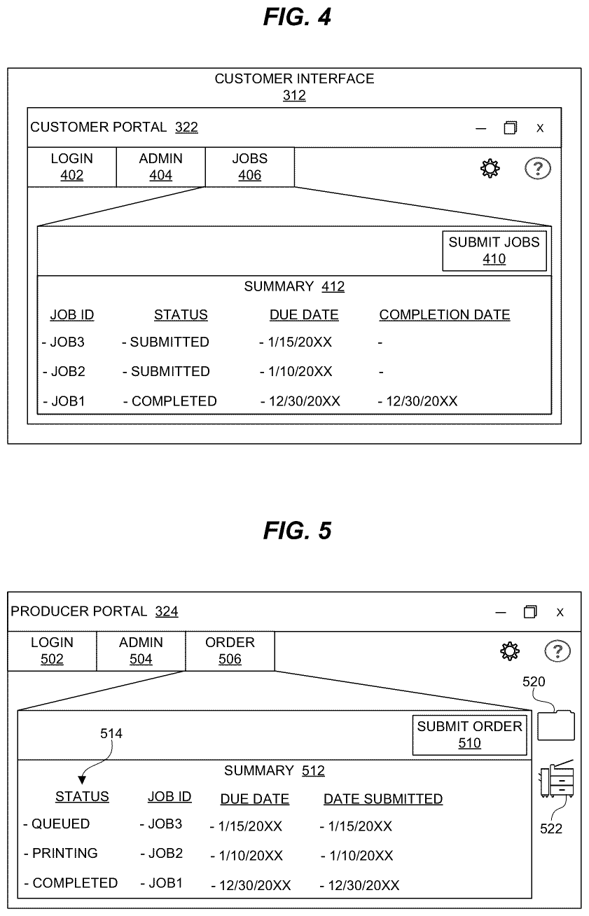

Customer interface 312 is a module or component of the cloud printing service 210 that interacts with users 240. For example, customer interface 312 may receive print jobs 202 submitted by users 240 to the cloud printing service 210, such as through an end user device 120. Customer interface 312 may provide status information 344 for the print jobs 202 to a user 240. In an embodiment, customer interface 312 may provide a website, a portal, a dashboard, a Graphical User Interface (GUI), or some other digital or graphical interface configured to interact with a user 240. For example, customer interface 312 may provide a customer portal 322 that allows a user 240 access to the cloud printing service 210. Cloud printing application 310 may be implemented in a multi-tenant cloud environment that is used by multiple different customers. Thus, each customer may be provided with a separate, secure space for accessing the cloud printing service 210 through customer portal 322. FIG. 4 is a block diagram of a customer portal 322 in an illustrative embodiment. Customer portal 322 may include icons, graphic representations or graphical elements, windows, screens, pages, etc., for interacting with a user 240. For example, customer portal 322 may provide a login page 402 (or window, screen, icon, etc.) configured to authenticate a user 240 for the cloud printing service 210. Customer portal 322 may provide an administration page 404 configured to allow a user 240 to define settings for the cloud printing service 210. Customer portal 322 may provide a jobs page 406 configured to allow a user 240 to manage print jobs 202 within the cloud printing service 210. For example, jobs page 406 may comprise a submit jobs graphical element 410 or button selectable by the user 240 to submit one or more print jobs 202 to the cloud printing service 210. Jobs page 406 may also comprise a summary graphical element 412 summarizing one or more print jobs 202 submitted to the cloud printing service 210, such as a job identifier (ID) or name, status information, a due date, a completion date, etc. However, jobs page 406 and/or customer portal 322 may have other formats or content as desired to manage print jobs 202 in the cloud printing service 210. In other embodiments, customer interface 312 may allow users 240 to submit print jobs 202 through email, File Transfer Protocol (FTP), or through another means.

In FIG. 3, workflow controller 314 is configured to manage workflows for print jobs 202 submitted to the cloud printing service 210. For example, workflow controller 314 may be configured to scan incoming job files for malware, extract metadata from the job files, convert the job files to a standard format (e.g., .pdf) if needed, preflight the job files to identify any potential problems, identify printers 221-226 available and/or capable of printing print jobs 202, schedule print jobs 202 directed to specific printers 221-226 (e.g., based on input from a producer 228), etc. In an embodiment, workflow controller 314 may provide a website, a portal, a dashboard, a GUI, or some other digital or graphical interface configured to interact with a producer 228 (e.g., a PSP operator). For example, workflow controller 314 may provide a producer portal 324 that allows a producer 228 access to the cloud printing service 210. FIG. 5 is a block diagram of a producer portal 324 in an illustrative embodiment. For example, producer portal 324 may provide a login page 502 (or window, screen, icon, etc.) configured to authenticate a producer 228 for the cloud printing service 210. Producer portal 324 may provide an administration page 504 configured to allow a producer 228 to define settings for the cloud printing service 210. Producer portal 324 may provide an order page 506 configured to allow a producer 228 to manage and/or order printing of print jobs 202 through the cloud printing service 210. For example, order page 506 may comprise a submit order graphical element 510 or button selectable by the producer 228 to print one or more print jobs 202 from the cloud printing service 210 to one or more printers 221-226. Producer 228 may drag and drop print jobs 202 into a hot folder icon 520, a printer icon 522 associated with a specific printer 221-226, etc. Order page 506 may also comprise a summary graphical element 512 summarizing one or more print jobs 202 submitted through the cloud printing service 210, such as status information 514, a job ID or name, a due date, a submission date, etc. Of note, the status information 514 is updated based on the status notifications provided by cloud print mediators 220 to the cloud printing service 210. Although one example is shown, order page 506 and/or producer portal 324 may have other formats or content as desired.

In FIG. 3, ground interface 316 is a module or component of the cloud printing service 210 that interacts with on-premise infrastructure 211, such as one or more cloud print mediators 220. For example, ground interface 316 may submit a print job 202, a print request, an instruction, control information, etc., (generally referred to as print job information 340) from the cloud printing service 210 to a cloud print mediator 220 regarding a print job 202 scheduled for printing at an associated printer 221-226 under the domain of the cloud print mediator 220. Ground interface 316 may receive status notifications 342 (also referred to as status updates) from a cloud print mediator 220 regarding the status of print jobs 202, the status of printers 221-226, etc. Workflow controller 314 may use the status notifications 342 to update the status information 514 presented at the producer portal 324, and customer interface 312 may use the status notifications 342 to provide status information 344 to the user 240 through customer portal 322.

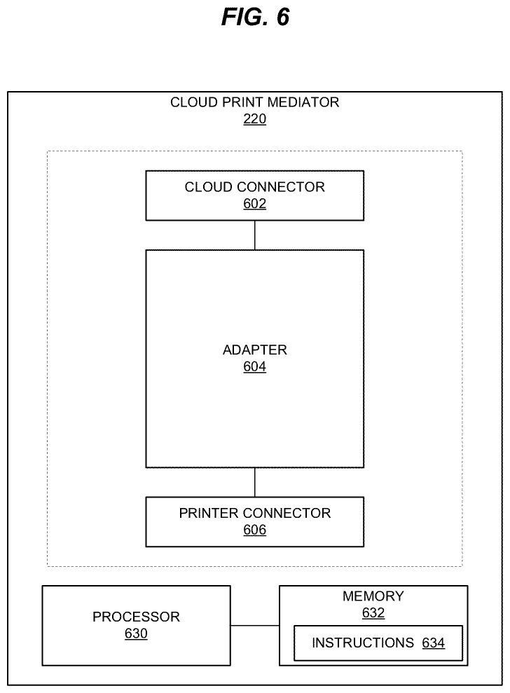

FIG. 6 is a block diagram of a cloud print mediator 220 in an illustrative embodiment. In an embodiment, cloud print mediator 220 includes the following subsystems: a cloud connector 602, an adapter 604, and a printer connector 606. Cloud connector 602 is an information processing apparatus comprising circuitry, logic, hardware, an application, means, etc., configured to communicate with a cloud printing service 210, such as ground interface 316. Cloud connector 602 is configured to provide or establish one or more connections or communication channels with the cloud printing service 210, to manage communication with the cloud printing service 210, etc. For example, cloud connector 602 may exchange communications with the cloud printing application 310 over one or more network connections 232 (see FIG. 2) via the internet 230, such as messages, data, print job information 340, status notifications 342, etc. Cloud connector 602 may use a variety of protocols for communication, such as an Application Programming Interface (API), data and/or network management protocols, transfer protocols, messaging protocol, etc. Functions or tasks of cloud connector 602 may include receiving or retrieving print jobs 202 submitted by the cloud printing service 210, such as one or more job files (e.g., Portable Document Format (PDF) files), a job ticket (e.g., Job Definition Format (JDF) job ticket or file) describing attributes for printing the print job 202 (e.g., media size, number of copies, color or greyscale, resolution, etc.), and/or other job-related information. Functions or tasks of cloud connector 602 may also include reporting status notifications 342 regarding the print jobs 202 and/or printers 221-226 to the cloud printing service 210, reporting device capabilities for printers 221-226 or associated post-print or finishing devices to the cloud printing service 210, etc.

Printer connector 606 is an information processing apparatus comprising circuitry, logic, hardware, an application, means, etc., configured to communicate with printers 221-226 and/or other printing equipment (e.g., post-print or finishing devices). Printer connector 606 may use a variety of protocols for communication. For example, printer connector 606 may exchange communications with printers 221-226 based on a native printer interface protocol of the printers 221-226, an API (e.g., Fiery API), TCP/IP, Line Printer Remote (LPR) protocol, Internet Printing Protocol (IPP), Postscript over a Transmission Control Protocol (TCP) port, Hypertext Transfer Protocol (HTTP)/HTTPS, Simple Network Management Protocol (SNMP), Job Messaging Format (JMF) protocol, etc. Functions or tasks of printer connector 606 may include submitting print jobs 202 to printers 221-226, receiving or retrieving status messages from the printers 221-226, receiving or retrieving device capabilities from the printers 221-226, etc.

Adapter 604 is communicatively coupled between cloud connector 602 and printer connector 606. Adapter 604 is an information processing apparatus comprising circuitry, logic, hardware, an application, means, etc., configured to queue print jobs 202 received through cloud connector 602 for submission to printer connector 606, to translate messages between cloud connector 602 and printer connector 606, and/or perform other functions. For example, cloud printing service 210 can scale easily and may be able to send print jobs 202 much faster than the printer connector 606 and/or the printers 221-226 can consume the print jobs 202. Adapter 604 may therefore act as a buffer to allow the cloud printing service 210 to run as fast it can without imposing any ground-side limitations. Adapter 604 is further configured to manage or translate instruction or command messages received from the cloud printing service 210 through cloud connector 602, manage or translate status messages received from printers 221-226 through printer connector 606, manage or translate device capability messages received from printers 221-226 through printer connector 606, etc.

One or more of the subsystems of cloud print mediator 220 may be implemented on a hardware platform comprised of analog and/or digital circuitry. One or more of the subsystems of cloud print mediator 220 may be implemented on a processor 630 that executes instructions 634 stored in memory 632. A processor 630 comprises an integrated hardware circuit configured to execute instructions 634 to provide the functions of cloud print mediator 220. Processor 630 may comprise a set of one or more processors or may comprise a multi-processor core, depending on the particular implementation. Memory 632 is a non-transitory computer readable medium for data, instructions, applications, etc., and is accessible by processor 630. Memory 632 is a hardware storage device capable of storing information on a temporary basis and/or a permanent basis. Memory 632 may comprise a random-access memory, or any other volatile or non-volatile storage device.

Cloud print mediator 220 may comprise various other components not specifically illustrated in FIG. 6. In an embodiment, cloud print mediator 220 may be implemented on a separate platform from one or more printers, such as for legacy printers 134. In an embodiment, cloud print mediator 220 may be implemented on or integrated in a common or same platform as a printer, such as for a cloud-ready or cloud-enabled printer 132.

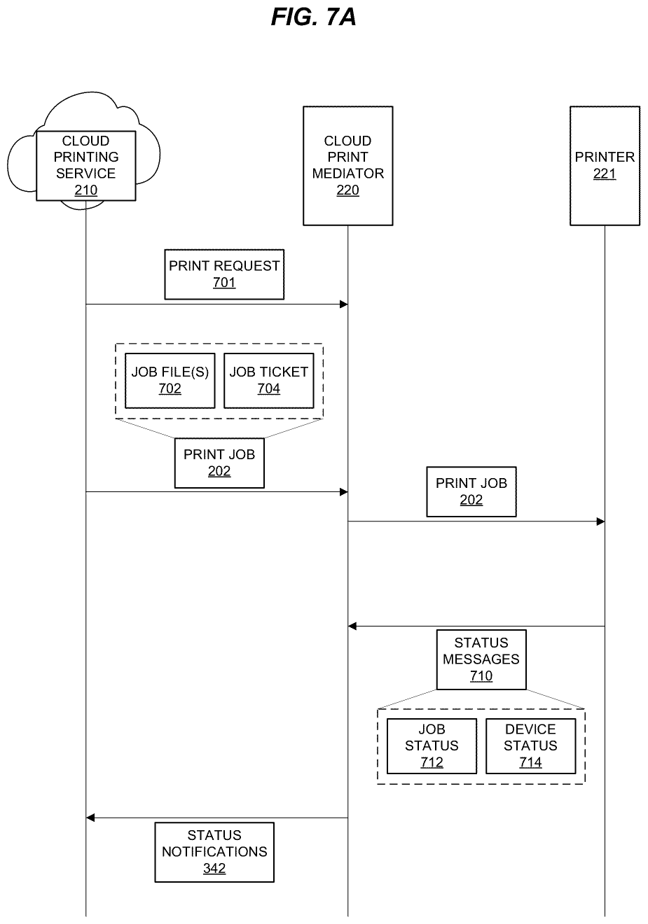

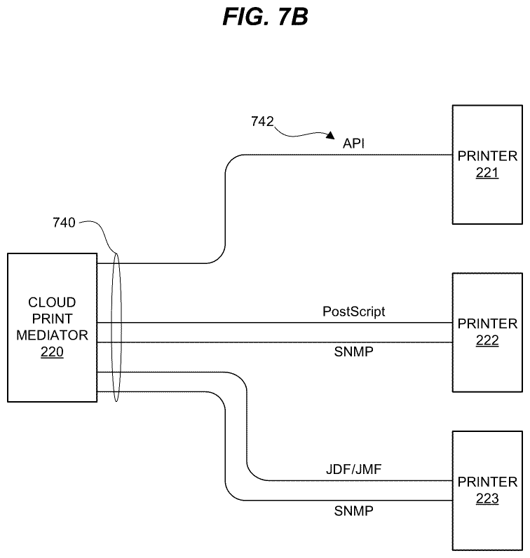

FIGS. 7A-7B illustrate communications involving a cloud printing service 210 in illustrative embodiments. In FIG. 7A, the cloud printing service 210 (e.g., through cloud printing application 310) submits a print job 202 to cloud print mediator 220 (e.g., through ground interface 316). To do so, the cloud printing service 210 sends a print request 701 to the cloud print mediator 220 to print a print job 202 on one or more selected printers 221-226, and also makes the print data for the print job 202 available for transfer or download by the cloud print mediator 220. The print job 202 may include one or more job files 702, a job ticket 704, and/or other print job information 340. Upon receiving the print job 202, cloud print mediator 220 may queue the print job 202, and then send the print job 202 to the printer 221 over a printer connection.

FIG. 7B illustrates connectivity between cloud print mediator 220 and printers 221-223 in an illustrative embodiment. Cloud print mediator 220 (through printer connector 606) is communicatively coupled to a printer 221-223 over one or more printer connections 740 (i.e., wired or wireless connections). Cloud print mediator 220 may communicate with a printer 221-223 using a variety of printer connection types or protocols, such as an API 742, SNMP, JMF, and/or another protocol to provide the print job 202 and any another job-related information to a printer 221-223, receive updates from a printer 221-223, receive device capabilities from a printer, etc. As an example, printer connector 606 may use an API 742 to send a job file (e.g., a .pdf file), a list of attribute value pairs that represents job ticket settings in that particular API's representation, and or other job data to a printer 221. Printer connector 606 may also use the API 742 to gather information and/or status updates from the printer 221. In another example, printer connector 606 may send the print job 202 to a printer 222 as Postscript job data. In a Postscript interface, the job ticket settings are converted to Postscript and embedded in the job data. Printer connector 606 may use SNMP, for example, to gather information and/or status updates from the printer 222. For instance, printer connector 606 may subscribe for SNMP alerts (called Traps), may poll printer 222 for status updates (e.g., job and/or printer updates), etc. In another example, printer connector 606 may use JDF/JMF to submit job data (i.e., job file and job ticket) to a printer 223. Printer connector 606 may use JMF to gather information and/or status updates. For instance, printer connector 606 may subscribe for JMF alerts (called signals), may poll printer 223 for status updates (e.g., job and/or printer updates), etc. Printer connector 606 may alternatively use SNMP to gather information and/or status updates from the printer 223. FIG. 7B illustrates some examples of protocols used between cloud print mediator 220 and printers 221-223, and other printer connection types and protocols are considered herein.

In processing print jobs 202, for example, printers 221-226 generate status messages that are received at cloud print mediator 220. In FIG. 7A, for example, cloud print mediator 220 receives status messages 710 from printer 221, such as when processing or consuming the submitted print job 202. For example, cloud print mediator 220 may subscribe to receive status messages 710 from a printer 221, may poll a printer 221 for status messages 710, etc. Status messages 710 may comprise a job status 712 indicating details of printing the print job 202, a device status 714 indicating an operating state of the printer 221, and/or other status information or updates. Cloud print mediator 220 processes or interprets the status messages 710, and reports status notifications 342 to cloud printing service 210.

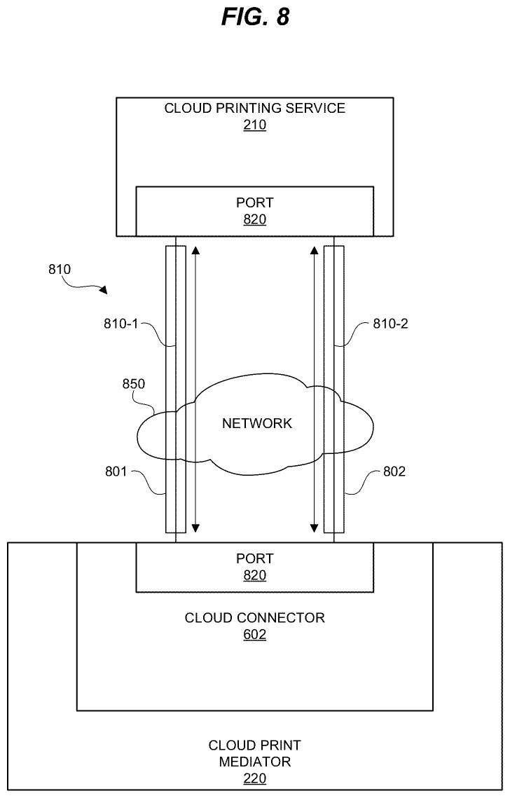

In embodiments described herein, cloud print mediator 220 communicates with the cloud printing service 210 over multiple network connections. FIG. 8 illustrates communication between cloud print mediator 220 and cloud printing service 210 in an illustrative embodiment. Cloud print mediator 220 and cloud printing service 210 are communicatively coupled over a network 850 (e.g., the internet) through a plurality of network connections 810 (also referred to as communication channels). A first one of the network connections 810-1 uses a secure messaging protocol 801 for communication, and may also be referred to as a messaging interface. A second one of the network connections 810-2 uses a secure transfer protocol 802 for communication, and may also be referred to as a data transfer interface. A secure messaging protocol 801 is an application layer protocol (e.g., Layer-7 of the network protocol stack, such as the Open Systems Interconnection (OSI) model) comprising rules, formats, and/or functions for exchanging messages (i.e., print-related messages) between the cloud and a ground system. The secure messaging protocol 801 has a constraint of a maximum message size, which is a message or payload less than a threshold, such as 128 kilobytes (KB), 256 KB, 512 KB, etc. One example of the secure messaging protocol 801 is Message Queuing Telemetry Transport (MQTT) protocol, which is a standards-based messaging protocol used for machine-to-machine communication. A secure transfer protocol 802 is an application layer protocol configured to transfer information (i.e., print-related data) between networked or network-connected devices. One example of the secure transfer protocol 802 is Hypertext Transfer Protocol Secure (HTTPS), which is an extension of the Hypertext Transfer Protocol (HTTP). HTTPS is an application layer protocol in the IP suite that uses Transport Layer Security (TLS) encryption for secure communication over a network, such as the internet.

Network-connected devices come equipped with standardized ports. A port is a virtual numbered address that is used as a communication endpoint by transport layer protocols (e.g., Layer-4 of the network protocol stack), such as User Diagram Protocol (UDP) or Transmission Control Protocol (TCP). The ports have an assigned number and the numbers are reserved for certain protocols and their associated function. The Internet Assigned Numbers Authority (IANA) is responsible for maintaining the official assignments of port numbers for specific uses. For example, port “80” is reserved for HTTP (i.e., unencrypted HTTP messages), while port “443” is reserved for HTTPS (i.e., encrypted HTTPS messages). In an embodiment, cloud print mediator 220 and cloud printing service 210 use a standardized port 820 (as opposed to a non-standardized port) for exchanging data over network connections 810. Standardized port 820 is used for secured transactions, and may be referred to as a secure standardized port 820.

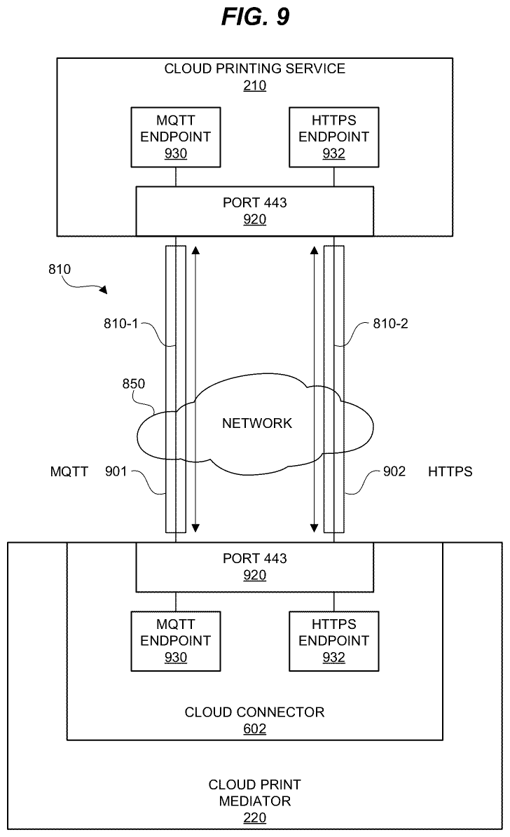

FIG. 9 illustrates communication between cloud print mediator 220 and cloud printing service 210 in an illustrative embodiment. In an embodiment, the secure messaging protocol 801 used for network connection 810-1 comprises MQTT protocol 901. Thus, cloud connector 602 and cloud printing service 210 (i.e., through ground interface 316) each implement an MQTT endpoint 930, which is an application, module, etc., configured to communicate via MQTT protocol 901. The MQTT endpoint 930 of cloud connector 602 may be referred to as an MQTT client, and the MQTT endpoint 930 of cloud printing service 210 may be referred to as an MQTT broker.

In an embodiment, the secure transfer protocol 802 used for network connection 810-2 comprises HTTPS protocol 902. Thus, cloud connector 602 and cloud printing service 210 (i.e., through ground interface 316) each implement an HTTPS endpoint 932, which is an application, module, etc., configured to communicate via HTTPS protocol 902. The HTTPS endpoint 932 of cloud connector 602 may be referred to as an HTTPS client, and the HTTPS endpoint 932 of cloud printing service 210 may be referred to as an HTTPS server (or vice-versa depending on the direction of communication).

In FIG. 9, cloud connector 602 and cloud printing service 210 use a standardized port 820 (i.e., port “443” 920) for exchanging data over network connections 810. HTTPS endpoints 932 designate port “443” 920 when exchanging HTTPS messages over network connection 810-2. For example, the transport layer operates on data segments each having an associated header. The header has, for example, a sequence number, a source port address, and a destination port address. An HTTPS endpoint 932 will therefore assign port “443” 920 as the source port address and/or destination port address for HTTPS messages. MQTT also uses port “443” 920, which is the same port used for HTTPS communications. Thus, MQTT endpoints 930 designate port “443” 920 when exchanging MQTT messages over network connection 810-1. One technical benefit is a standardized port 820 is used for both network connections 810, and a customer does not need to open a non-standardized port to implement communication with a cloud printing service 210.

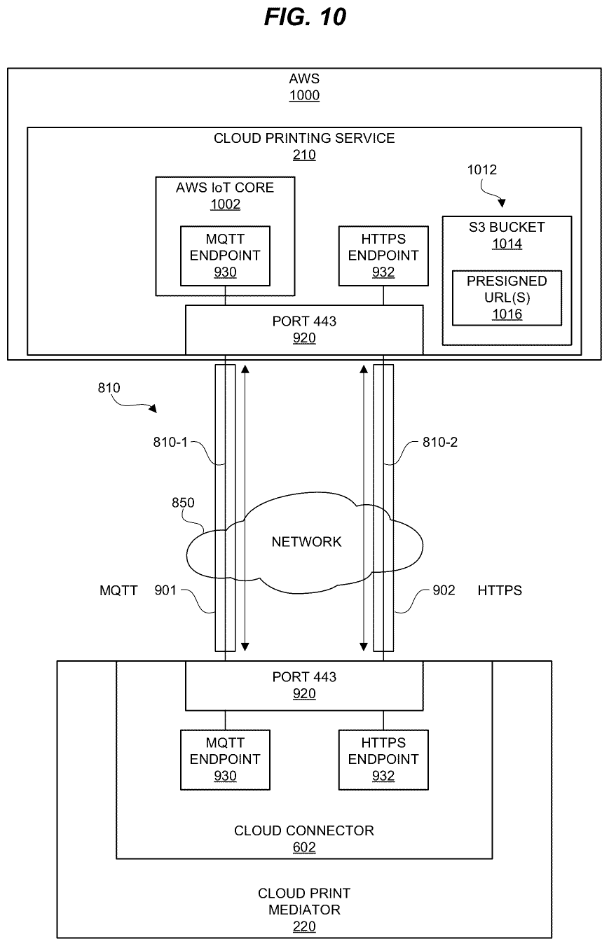

FIG. 10 illustrates communication between cloud print mediator 220 and cloud printing service 210 in an illustrative embodiment. In an embodiment, the cloud printing service 210 may be implemented in an AWS environment 1000. AWS is a platform that offers flexible and scalable cloud computing solutions. Thus, AWS environment 1000 comprises an environment that uses an AWS platform or a type of AWS platform (also referred to as an AWS-type environment), such as one that includes future developments of AWS or other Amazon cloud services. The AWS environment 1000 includes the AWS Internet of Things (IoT) Core 1002, which is a managed cloud service that lets connected devices easily and securely interact with cloud applications (e.g., cloud printing application 310) and other devices. The AWS IoT Core 1002 provides a fully managed palette of MQTT-based messaging features. Thus, the AWS IoT Core 1002 may comprise or provide an MQTT endpoint 930 (also referred to as an MQTT message broker) configured to communicate with a cloud connector 602.

The AWS environment 1000 further includes AWS storage services that provide scalable and secure storage for data. One of the AWS storage services is Amazon Simple Storage Service (Amazon S3) 1012, which is an object storage service. When a data file is uploaded to Amazon S3 1012, the data file is stored as an S3 object in an S3 bucket 1014. An S3 bucket 1014 is a container for objects. An object consists of a file (i.e., the file data) and metadata that describes the file. A customer or producer creates an S3 bucket 1014, and specifies a bucket name and AWS region. Data is uploaded to that S3 bucket 1014 as objects, and each object has a key (or key name), which is a unique identifier for the S3 object within the S3 bucket 1014.

By default, S3 objects are private and only the object owner has permission to access the S3 objects. However, the object owner may share objects with others by creating a presigned Uniform Resource Locator (URL) 1016. A presigned URL 1016 uses security credentials to grant time-limited permission to download objects. The presigned URL 1016 may be entered in a browser or used by a program, for example, to download the object from the S3 bucket 1014. The presigned URL 1016 may also be used to upload an object to the S3 bucket 1014. The cloud printing service 210 may store print data (e.g., job file(s) 702, job ticket 704, etc.) for a print job 202 in the S3 bucket 1014, which is accessible through the presigned URL 1016. One technical benefit is the cloud connector 602 may download print jobs 202 over HTTPS using the presigned URL 1016, without needing additional permissions.

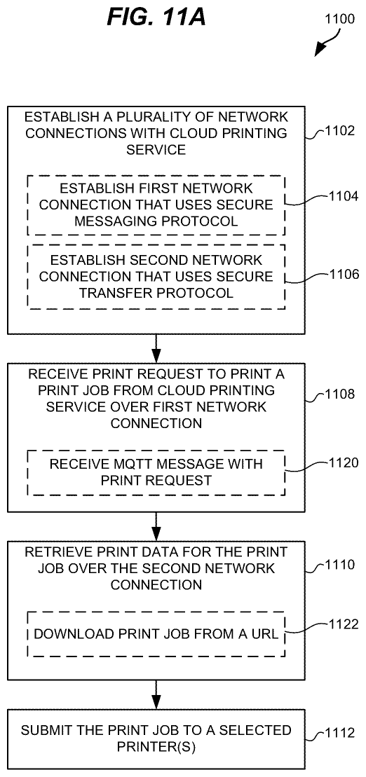

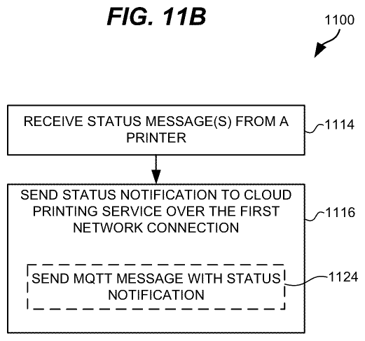

FIGS. 11A-11B are flow charts illustrating a method 1100 of communicating with a cloud printing service 210 in an illustrative embodiment. The steps of method 1100 will be described with reference to cloud print mediator 220 in FIG. 6, but those skilled in the art will appreciate that method 1100 may be performed in other systems or devices. Also, the steps of the flow charts described herein are not all inclusive and may include other steps not shown, and the steps may be performed in an alternative order.

In FIG. 11A, cloud print mediator 220 (i.e., through cloud connector 602) establishes or sets up a plurality of network connections 810 with the cloud printing service 210 (step 1102). In establishing the network connections 810, cloud print mediator 220 establishes a first network connection 810-1 that uses a secure messaging protocol 801 for communication (step 1104), and establishes a second network connection 810-2 that uses a secure transfer protocol 802 for communication (step 1106). Cloud print mediator 220 receives a print instruction or print request 701 to print a print job 202 from the cloud printing service 210 over the first network connection 810-1 (step 1108). For example, cloud print mediator 220 may receive an MQTT message over the first network connection 810-1 that includes a print request to print a print job (optional step 1120). In response to the print request 701, cloud print mediator 220 retrieves or obtains print data (e.g., job file(s) 702, job ticket 704, etc.) for the print job 202 over the second network connection 810-2 (step 1110). For example, cloud print mediator 220 may download the print job 202 from a URL (e.g., presigned URL 1016) or other address or storage location of the print job 202 (optional step 1122). Cloud print mediator 220 (through printer connector 606) then submits the print job 202 to at least one selected printer 221-226 for printing (step 1112). One technical benefit is the print data for the print job 202 may be quite large, making transmission of the print job 202 via messages over the first network connection 810-1 inefficient and/or cost prohibitive. Thus, smaller data such as the print request 701 may be sent over the first network connection 810-1, while larger data (e.g., more than the maximum message size, such as 128 KB payload) may be sent over the second network connection 810-2 (e.g., HTTPS).

In FIG. 11B, cloud print mediator 220 (through printer connector 606) receives status messages 710 from a printer 221-226 regarding processing of the print job 202 (step 1114). For example, printer connector 606 may subscribe to a printer 221-226 to receive status messages 710, may poll a printer 221-226 to receive status messages 710, etc. In response to one or more of the status messages 710, cloud print mediator 220 (i.e., through cloud connector 602) sends or provides a status notification 342 to cloud printing service 210 over the first network connection 810-1 based on the status messages 710 (step 1116). For example, cloud print mediator 220 may send one or more MQTT messages to the cloud printing service 210 with the status notification 342 (optional step 1124). Cloud print mediator 220 may trigger one MQTT message to the cloud printing service 210 per status message 710 received from a printer 221-226. Cloud print mediator 220 may aggregate multiple status messages 710 into an MQTT message sent to the cloud printing service 210. Cloud print mediator 220 may filter or throttle the status messages 710 received from a printer 221-226, and send an MQTT message to the cloud printing service 210 (e.g., that satisfies predefined filter or throttling criteria). One technical benefit is the size of status messages 710 are small enough to be sent to the cloud printing service 210 via the secure messaging protocol 801 (e.g., MQTT) used for the first network connection 810-1.

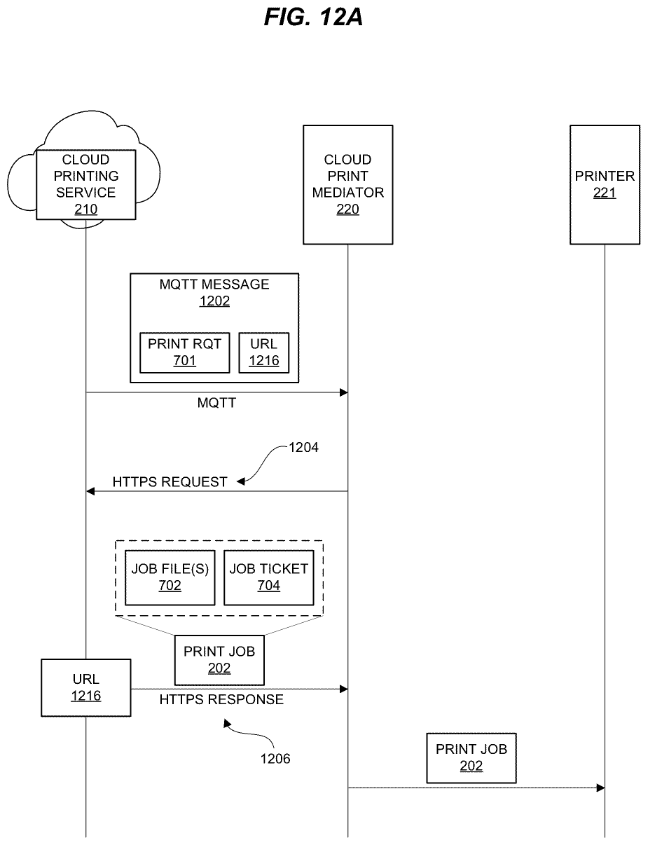

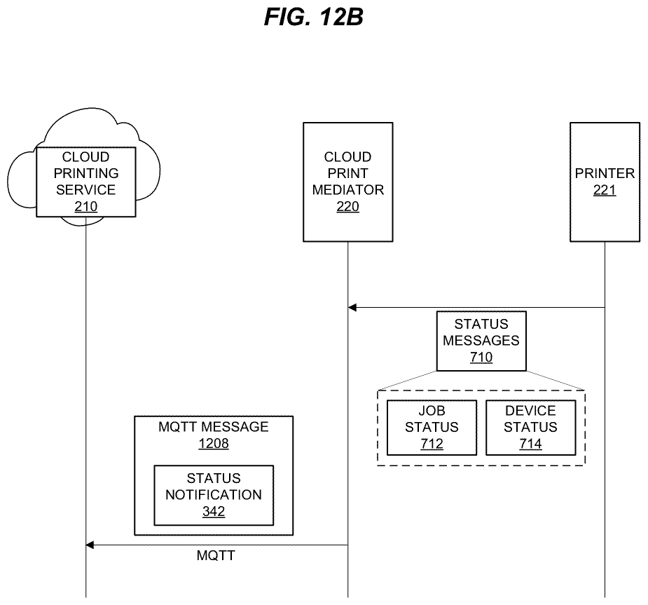

FIGS. 12A-12B are message diagrams illustrating communications with the cloud printing service 210 in an illustrative embodiment. An assumption in FIG. 12A is a user 240 submits a print job 202 to a cloud printing service 210, and the cloud printing service 210 selects a printer 221 for handling the print job 202. The cloud printing service 210 does not communicate directly with the selected printer 221, but instead communicates with the cloud print mediator 220. In this interaction, cloud print mediator 220 receives a print request 701 for the print job 202 from the cloud printing service 210 via an MQTT message 1202 over the first network connection 810-1. The MQTT message 1202 may identify the print job 202, identify the selected printer 221, identify a storage location of the print job 202, and/or include other information. In response to the print request 701, cloud print mediator 220 retrieves the print job 202 from the cloud printing service 210 over the second network connection 810-2. To do so, cloud print mediator 220 sends an HTTPS request 1204 (e.g., HTTP GET) to download the print job 202 from a storage location of the print job 202 over the second network connection 810-2. For example, the print job 202 may be stored at a storage location accessible via a URL 1216 (e.g., a presigned URL 1016), and the HTTPS request 1204 requests the resource (i.e., print job 202) associated with the URL 1216. The cloud print mediator 220 may receive a prior message from the cloud printing service 210 over the first network connection 810-1 indicating the URL. For example, the prior MQTT message 1202 or print request 701 may include or indicate the URL 1216 where the print job 202 is stored. Cloud print mediator 220 then receives an HTTPS response 1206 that contains print data for the print job 202 over the second network connection 810-2, such as one or more job files 702, a job ticket 704, and/or other print job information 340. Cloud print mediator 220 then submits the print job 202 to the selected printer 221.

In FIG. 12B, cloud print mediator 220 receives one or more status messages 710 from the printer 221 regarding processing of the print job 202. In response to one or more of the status messages 710, cloud print mediator 220 sends or provides a status notification 342 to cloud printing service 210 via an MQTT message 1208 over the first network connection 810-1.

The second network connection 810-2 may also be used to upload data or information to the cloud printing service 210. One example of data or information uploaded to the cloud printing service 210 is device capabilities of printers 221-226 and/or other printing equipment. Device capabilities are collected for the printing equipment under the domain of a cloud print mediator 220, and uploaded to the cloud printing service 210. This allows the cloud printing service 210 to select a certain printer for printing of a print job 202 based on the capabilities of the printer.

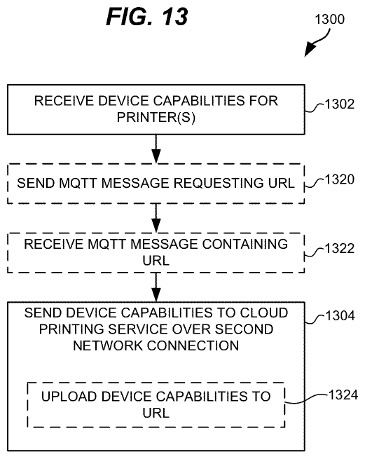

FIG. 13 is a flow chart illustrating a method 1300 of communicating with a cloud printing service 210 in an illustrative embodiment. Cloud print mediator 220 receives device capabilities for one or more printers 221-226 (step 1302). For example, cloud print mediator 220 may obtain, collect, or receive device capability (DEVCAP) information, device capability files, etc., from one or more of printers 221-226. The device capabilities indicate the printer capabilities and/or attributes of a printer. For example, the device capabilities may include a printer manufacturer, a printer model, a serial number, printer resolution, print engine type (e.g., color or monochrome), printer speed, media types supported, media sizes supported, PDLs supported (e.g., PostScript, Printer Command Languages (PCL), etc.), network protocols supported (e.g., TCP/IP, Line Printer Remote (LPR), Internet Printing Protocol (IPP), HTTP, SNMP, etc.), page layouts supported (e.g., N-up), post-print or finishing activities supported (e.g., binding, cutting/trimming, embossing, laminating, etc.), and/or other capabilities or attributes. Cloud print mediator 220 then sends the device capabilities to the cloud printing service 210 over the second network connection 810-2 (step 1304). For example, cloud print mediator 220 may upload the device capabilities to a URL (e.g., presigned URL 1016) using an HTTPS request over the second network connection 810-2 (optional step 1324). The cloud print mediator 220 may receive a prior message from the cloud printing service 210 over the first network connection 810-1 indicating the URL. For example, when cloud print mediator 220 receives the device capabilities from a printer 221-226, cloud print mediator 220 may send an MQTT message to the cloud printing service 210 requesting a URL for uploading the device capabilities (optional step 1320). In response, cloud printing service 210 creates the URL, and sends the URL via an MQTT message that is received by the cloud print mediator 220 (optional step 1322). The cloud print mediator 220 then sends the HTTPS request using the URL for uploading the device capabilities (optional step 1324). One technical benefit is the device capabilities, especially for multiple printers, may be quite large, making transmission of the device capabilities via messages over the first network connection 810-1 inefficient and/or cost prohibitive. Thus, the device capabilities may be sent over the second network connection 810-2 (e.g., HTTPS), which can handle larger data.

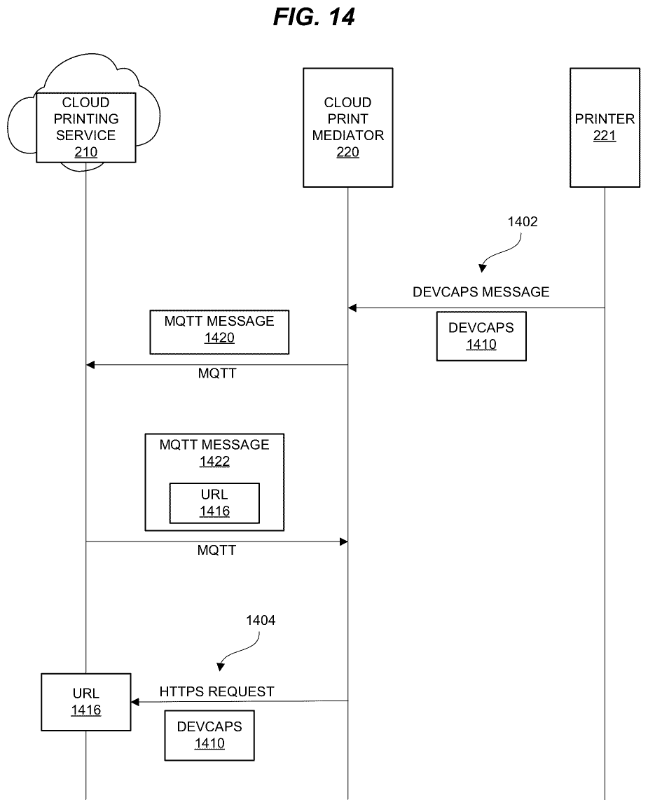

FIG. 14 is a message diagram illustrating communications with the cloud printing service 210 in an illustrative embodiment. Cloud print mediator 220 receives a device capabilities message 1402 from a printer 221 indicating the device capabilities 1410 (also referred to as device capability information or a device capabilities file) for that printer 221. Cloud print mediator 220 then sends the device capabilities 1410 to the cloud printing service 210 over the second network connection 810-2. To do so, cloud print mediator 220 may, in response to receiving the device capabilities 1410 from printer 221, send an MQTT message 1420 to the cloud printing service 210 requesting a URL 1416 for uploading the device capabilities 1410. Cloud printing service 210 creates the URL 1416, and sends the URL 1416 via an MQTT message 1422 that is received by the cloud print mediator 220. The cloud print mediator 220 sends an HTTPS request 1404 (e.g., HTTP PUT) to upload the device capabilities 1410 to a storage location over the second network connection 810-2. For example, cloud print mediator 220 may upload the device capabilities 1410 to a storage location accessible via the URL 1416 (e.g., a presigned URL 1016) provided in a prior MQTT message 1422. In another example, when a printer object is created on the cloud printing service 210 or printer characteristics are modified, such as for printer 221, a URL 1416 may be created or defined. Cloud print mediator 220 may receive an MQTT message 1422 from the cloud printing service 210 indicating the URL 1416, and upload the device capabilities 1410 to that URL 1416. Cloud print mediator 220 may perform similar operations for multiple printers 221-226 and/or other print equipment.

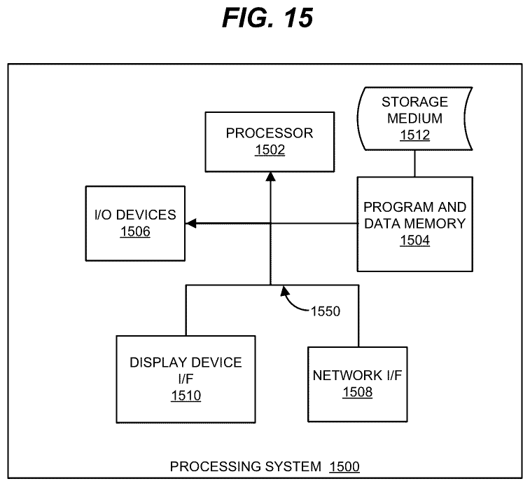

Embodiments disclosed herein can take the form of software, hardware, firmware, or various combinations thereof. FIG. 15 illustrates a processing system 1500 operable to execute a computer readable medium embodying programmed instructions to perform desired functions in an illustrative embodiment. Processing system 1500 is operable to perform the above operations by executing programmed instructions tangibly embodied on computer readable storage medium 1512. In this regard, embodiments can take the form of a computer program accessible via computer-readable medium 1512 providing program code for use by a computer or any other instruction execution system. For the purposes of this description, computer readable storage medium 1512 can be anything that can contain or store the program for use by the computer.

Computer readable storage medium 1512 can be an electronic, magnetic, optical, electromagnetic, infrared, or semiconductor device. Examples of computer readable storage medium 1512 include a solid-state memory, a magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W), and DVD.

Processing system 1500, being suitable for storing and/or executing the program code, includes at least one processor 1502 coupled to program and data memory 1504 through a system bus 1550. Program and data memory 1504 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 1506 (including but not limited to keyboards, displays, pointing devices, etc.) can be coupled either directly or through intervening I/O controllers. Network adapter interfaces 1508 may also be integrated with the system to enable processing system 1500 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 1510 may be integrated with the system to interface to one or more display devices, such as printing systems and screens for presentation of data generated by processor 1502.

The following clauses and/or examples pertain to further embodiments or examples. Specifics in the examples may be used anywhere in one or more embodiments. The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein.

Some embodiments pertain to Example 1 that includes an apparatus comprising a cloud print mediator configured to communicatively couple between a plurality of printers and a cloud printing service provisioned on a cloud-computing platform. The cloud print mediator comprises at least one processor and memory. The at least one processor is configured to cause the cloud print mediator at least to: establish a first network connection with the cloud printing service that uses a secure messaging protocol, establish a second network connection with the cloud printing service that uses a secure transfer protocol, receive a print request to print a print job from the cloud printing service over the first network connection, retrieve print data for the print job from the cloud printing service over the second network connection, and submit the print job to a selected printer of the plurality.

Example 2 includes the subject matter of Example 1, where the secure messaging protocol used for the first network connection comprises Message Queuing Telemetry Transport (MQTT) protocol, and the secure transfer protocol used for the second network connection comprises Hypertext Transfer Protocol secure (HTTPS).

Example 3 includes the subject matter of Examples 1 and 2, where the at least one processor is further configured to cause the cloud print mediator at least to use a same secure standardized port for the first network connection and the second network connection.

Example 4 includes the subject matter of Examples 1-3, where the secure standardized port comprises port “443”

Example 5 includes the subject matter of Examples 1-4, where the secure transfer protocol used for the second network connection comprises Hypertext Transfer Protocol secure (HTTPS), and the at least one processor is further configured to cause the cloud print mediator at least to download the print data for the print job from the cloud printing service over the second network connection using a Uniform Resource Locator (URL).

Example 6 includes the subject matter of Example 1-5, where the at least one processor is further configured to cause the cloud print mediator at least to receive status messages from the selected printer regarding processing of the print job, and send status notifications to the cloud printing service in response to the status messages received from the selected printer over the first network connection.

Example 7 includes the subject matter of Examples 1-6, where the status messages comprise at least one of a job status of the print job and a device status of the selected printer.

Example 8 includes the subject matter of Examples 1-7, where the at least one processor is further configured to cause the cloud print mediator at least to receive device capabilities from at least one of the printers, and send the device capabilities to the cloud printing service over the second network connection.

Example 9 includes the subject matter of Examples 1-8, where the secure transfer protocol used for the second network connection comprises Hypertext Transfer Protocol secure (HTTPS), and the at least one processor is further configured to cause the cloud print mediator at least to upload the device capabilities to the cloud printing service over the second network connection using a Uniform Resource Locator (URL).

Example 10 includes the subject matter of Examples 1-9, where a printing system comprises the cloud print mediator and the printers.

Some embodiments pertain to Example 11 that includes a method of communicating with a cloud printing service, the method comprising: in a cloud print mediator communicatively coupled between a plurality of printers and the cloud printing service provisioned on a cloud-computing platform: establishing a first network connection with the cloud printing service that uses a secure messaging protocol establishing a second network connection with the cloud printing service that uses a secure transfer protocol, receiving a print request to print a print job from the cloud printing service over the first network connection, retrieving print data for the print job from the cloud printing service over the second network connection, and submitting the print job to a selected printer of the plurality.

Example 12 includes the subject matter of Example 11, where the secure messaging protocol used for the first network connection comprises Message Queuing Telemetry Transport (MQTT) protocol, and the secure transfer protocol used for the second network connection comprises Hypertext Transfer Protocol secure (HTTPS).

Example 13 includes the subject matter of Examples 11 and 12, where the first network connection and the second network connection use a same secure standardized port.

Example 14 includes the subject matter of Examples 11-13, where the secure standardized port comprises port “443”.

Example 15 includes the subject matter of Examples 11-14, where the secure transfer protocol used for the second network connection comprises Hypertext Transfer Protocol secure (HTTPS), and the retrieving the print data comprises downloading the print data for the print job from the cloud printing service over the second network connection using a Uniform Resource Locator (URL).

Example 16 includes the subject matter of Examples 11-15, further comprising: receiving status messages from the selected printer regarding processing of the print job, and sending status notifications to the cloud printing service in response to the status messages received from the selected printer over the first network connection.

Example 17 includes the subject matter of Examples 11-16, where the status messages comprise at least one of a job status of the print job and a device status of the selected printer.

Example 18 includes the subject matter of Examples 11-17, further comprising: receiving device capabilities from at least one of the printers, and sending the device capabilities to the cloud printing service over the second network connection.

Example 19 includes the subject matter of Examples 11-18, where the secure transfer protocol used for the second network connection comprises Hypertext Transfer Protocol secure (HTTPS), and the sending the device capabilities comprises uploading the device capabilities to the cloud printing service over the second network connection using a Uniform Resource Locator (URL).

Some embodiments pertain to Example 20 that includes a non-transitory computer readable medium embodying programmed instructions executed by a processor, where the instructions direct the processor to implement a method of communicating with a cloud printing service, the method comprising, in a cloud print mediator communicatively coupled between a plurality of printers and the cloud printing service provisioned on a cloud-computing platform: establishing a first network connection with the cloud printing service that uses a secure messaging protocol, establishing a second network connection with the cloud printing service that uses a secure transfer protocol, receiving a print request to print a print job from the cloud printing service over the first network connection, retrieving print data for the print job from the cloud printing service over the second network connection, and submitting the print job to a selected printer of the plurality.

Although specific embodiments were described herein, the scope of the invention is not limited to those specific embodiments. The scope of the invention is defined by the following claims and any equivalents thereof.

What is claimed is:

1. An apparatus, comprising:
a cloud print mediator configured to communicatively couple between a plurality of printers and a cloud printing service provisioned on a cloud-computing platform;
the cloud print mediator comprising at least one processor and memory;
the at least one processor configured to cause the cloud print mediator at least to:
establish a first network connection with the cloud printing service that uses a secure messaging protocol;
establish a second network connection with the cloud printing service that uses a secure transfer protocol;
receive a print request to print a print job from the cloud printing service over the first network connection;
retrieve print data for the print job from the cloud printing service over the second network connection; and
submit the print job to a selected printer of the plurality.

2. The apparatus of claim 1, wherein:
the secure messaging protocol used for the first network connection comprises Message Queuing Telemetry Transport (MQTT) protocol; and
the secure transfer protocol used for the second network connection comprises Hypertext Transfer Protocol secure (HTTPS).

3. The apparatus of claim 1, wherein the at least one processor is further configured to cause the cloud print mediator at least to:
use a same secure standardized port for the first network connection and the second network connection.

4. The apparatus of claim 3, wherein:
the secure standardized port comprises port “443”.

5. The apparatus of claim 1, wherein:
the secure transfer protocol used for the second network connection comprises Hypertext Transfer Protocol secure (HTTPS); and
the at least one processor is further configured to cause the cloud print mediator at least to:
download the print data for the print job from the cloud printing service over the second network connection using a Uniform Resource Locator (URL).

6. The apparatus of claim 1, wherein the at least one processor is further configured to cause the cloud print mediator at least to:
receive status messages from the selected printer regarding processing of the print job; and
send status notifications to the cloud printing service in response to the status messages received from the selected printer over the first network connection.

7. The apparatus of claim 6, wherein:
the status messages comprise at least one of a job status of the print job and a device status of the selected printer.

8. The apparatus of claim 1, wherein the at least one processor is further configured to cause the cloud print mediator at least to:
receive device capabilities from at least one of the printers; and
send the device capabilities to the cloud printing service over the second network connection.

9. The apparatus of claim 8, wherein:
the secure transfer protocol used for the second network connection comprises Hypertext Transfer Protocol secure (HTTPS); and
the at least one processor is further configured to cause the cloud print mediator at least to:
upload the device capabilities to the cloud printing service over the second network connection using a Uniform Resource Locator (URL).

10. A printing system, comprising:
the cloud print mediator of claim 1; and
the printers.

11. A method of communicating with a cloud printing service, the method comprising:
in a cloud print mediator communicatively coupled between a plurality of printers and the cloud printing service provisioned on a cloud-computing platform:
establishing a first network connection with the cloud printing service that uses a secure messaging protocol;
establishing a second network connection with the cloud printing service that uses a secure transfer protocol;
receiving a print request to print a print job from the cloud printing service over the first network connection;
retrieving print data for the print job from the cloud printing service over the second network connection; and
submitting the print job to a selected printer of the plurality.

12. The method of claim 11, wherein:
the secure messaging protocol used for the first network connection comprises Message Queuing Telemetry Transport (MQTT) protocol; and
the secure transfer protocol used for the second network connection comprises Hypertext Transfer Protocol secure (HTTPS).

13. The method of claim 11, wherein:
the first network connection and the second network connection use a same secure standardized port.

14. The method of claim 13, wherein:
the secure standardized port comprises port “443”.

15. The method of claim 11, wherein:
the secure transfer protocol used for the second network connection comprises Hypertext Transfer Protocol secure (HTTPS); and
the retrieving the print data comprises downloading the print data for the print job from the cloud printing service over the second network connection using a Uniform Resource Locator (URL).

16. The method of claim 11, further comprising:
receiving status messages from the selected printer regarding processing of the print job; and
sending status notifications to the cloud printing service in response to the status messages received from the selected printer over the first network connection.

17. The method of claim 16, wherein:
the status messages comprise at least one of a job status of the print job and a device status of the selected printer.

18. The method of claim 11, further comprising:
receiving device capabilities from at least one of the printers; and
sending the device capabilities to the cloud printing service over the second network connection.

19. The method of claim 18, wherein:
the secure transfer protocol used for the second network connection comprises Hypertext Transfer Protocol secure (HTTPS); and
the sending the device capabilities comprises uploading the device capabilities to the cloud printing service over the second network connection using a Uniform Resource Locator (URL).

20. A non-transitory computer readable medium embodying programmed instructions executed by a processor, wherein the instructions direct the processor to implement a method of communicating with a cloud printing service, the method comprising:
in a cloud print mediator communicatively coupled between a plurality of printers and the cloud printing service provisioned on a cloud-computing platform:
establishing a first network connection with the cloud printing service that uses a secure messaging protocol;
establishing a second network connection with the cloud printing service that uses a secure transfer protocol;
receiving a print request to print a print job from the cloud printing service over the first network connection;
retrieving print data for the print job from the cloud printing service over the second network connection; and
submitting the print job to a selected printer of the plurality.
